(19) United States
(12) Patent Application Publication
(10) Pub. No.: US 2026/0332336 A1
(43) Pub. Date: Oct. 22, 2026

(54) AMBIENT POWER MAC SAP INTERFACE AND FRAME EXCHANGE SEQUENCE

(71) Applicant: NXP USA, Inc., AUSTIN, TX (US)

(72) Inventors: Liwen Chu, San Ramon, CA (US); Rui Cao, Sunnyvale, CA (US); Hongyuan Zhang, Fremont, CA (US)

(21) Appl. No.: 19/650,066

(22) Filed: Apr. 16, 2026

Related U.S. Application Data
(60) Provisional application No. 63/789,650, filed on Apr. 16, 2025.

(51) Int. Cl. H04L 5/00; H02J 50/00; H02J 50/80

(52) U.S. Cl. CPC H04L 5/0048; H02J 50/80; H02J 50/001

(57) ABSTRACT

Methods and apparatus are provided for communicating information between an ambient power (AMP) compliant first device and an AMP compliant second device (e.g., a wireless tag). A method includes communicating, from an upper layer of a MAC layer (“upper layer”) of the first device to the MAC layer, a request primitive to solicit a response from an upper layer of the second device. The method further includes configuring, by the MAC layer of the first device, one or more frames to solicit the response from the upper layer of the second device and transmitting the one or more frames to the second device. The method further includes decoding (by the second device) the one or more frames, communicating an indication primitive to the upper layer of the second device, and communicating, from the upper layer of the second device to the MAC layer, a request primitive solicited by the indication primitive.

### CROSS REFERENCE TO RELATED APPLICATIONS

The present U.S. Utility Patent Application claims priority pursuant to 35 U.S.C. §119(e) to U.S. Provisional Application No. 63/789,650, entitled “AMP MAC SAP INTERFACE AND FRAME EXCHANGE SEQUENCE”, filed Apr. 16, 2025, the contents of which is hereby incorporated herein by reference in its entirety and made part of the present U.S. Utility Patent Application for all purposes.

### TECHNICAL FIELD

This disclosure relates generally to data communications, and more particularly, to methods and apparatus for ambient power communications based on Institute of Electrical and Electronics Engineers (IEEE) 802.11bp.

### BACKGROUND

Existing Ultra-High Frequency Radio Frequency Identification (UHF RFID) standards, such as the Electronic Product Code Generation 2 standard (EPC Gen2/ISO 18000-63), provide an air-interface protocol that defines how passive RFID tags and readers communicate through battery-less backscattering in the UHF band (approximately 860-930 MHz). Ambient Power (AMP) communication is currently being discussed in the Institute of Electrical and Electronics Engineers (IEEE) Task Group bp for the 802.11bp amendment to the 802.11 (WiFi) standard. AMP communication is intended to enable low power operation of AMP tag devices through battery-less backscattering in a 2.4 GHz range.

### SUMMARY

The innovative apparatus, frame exchange sequences, and methods illustrated in the figures and described herein enable ambient power (AMP) communications between an AMP compliant WiFi device and a second device (e.g., a wireless tag). In an illustrative, non-limiting embodiment, a method for communicating information between an ambient power (AMP) compliant first device and an AMP compliant second device is provided. The method includes communicating, from an upper layer of a MAC layer (“upper layer”) of the first device to the MAC layer of the first device, a request primitive to solicit a response from an upper layer of the second device. The method further includes configuring, by the MAC layer of the first device, one or more frames to solicit the response from the upper layer of the second device and transmitting the one or more frames from the first device to the second device. The method further includes decoding the one or more frames by the second device, communicating an indication primitive to the upper layer of the second device based on the decoded one or more frames, and communicating, from the upper layer of the second device to the MAC layer of the second device, a request primitive solicited by the indication primitive.

The method of this embodiment includes optional aspects. With one optional aspect, the request primitive of the first device includes a different set of parameters than the request primitive of the second device. In another optional aspect, the request primitive of the first device includes a parameter identifying a requested tag type. With another optional aspect, the request primitive of the first device further includes a response delay parameter and a response length parameter. In another optional aspect, the request primitive of the first device includes a response delay parameter and a response length parameter.

In another optional aspect, the second device is a wireless tag that maintains an Electronic Product Code (EPC) sent flag. In a further optional aspect, the method further includes receiving, by the wireless tag, a broadcast Trigger frame from the first device that announces a random access slot for a monostatic backscattering use case. This optional aspect further includes, in response to successfully contending for the random access slot, transmitting a responsive frame including a CRC-based identifier of the wireless tag and setting the EPC sent flag to 0 if it is set to 1 at a time the broadcast Trigger frame is received. In a further optional aspect, the method further includes transmitting, by the wireless tag, an EPC code of the wireless tag after receiving a unicast soliciting frame that includes the CRC-based identifier in a MAC header of the unicast soliciting frame and setting the EPC sent flag to 1. In another optional aspect, the method further includes receiving, by the wireless tag, a unicast Trigger frame addressed to the wireless tag, determining that the EPC sent flag is set to 1 and, in response, transmitting a response to the unicast Trigger frame. In yet another optional aspect, the method further includes receiving, by the wireless tag, a unicast Trigger frame addressed to the wireless tag, determining that the EPC sent flag is set to 0 and, in response, determining not to transmit a response to the unicast Trigger frame. In another optional aspect, the one or more frames are compliant with an Institute of Electrical and Electronics Engineers (IEEE) 802.11bp amendment to the IEEE 802.11 standard.

With another illustrative, non-limiting embodiment, a method for communicating with an ambient power (AMP) compliant WiFi device by an AMP tag is provided. The method includes receiving, from the AMP compliant WiFi device, one or more frames, wherein the one or more frames are configured in accordance with a first request primitive from an upper layer of a MAC layer (“upper layer”) of the AMP compliant WiFi device to solicit a response from the AMP tag. The method further includes decoding, by the AMP tag, the one or more frames and communicating, based on the decoded one or more frames, an indication primitive to an upper layer of the AMP tag. The method further includes communicating, from the upper layer of the AMP tag to the MAC layer of the AMP tag, a second request primitive solicited by the indication primitive. The method further includes transmitting, by the AMP tag, a frame encapsulating the response.

This embodiment includes optional aspects. With one optional aspect, the second request primitive includes a different set of parameters than the first request primitive. In another optional aspect, the first request primitive includes a parameter identifying a requested tag type, a response delay parameter and a response length parameter. In a further optional aspect, the AMP tag maintains an Electronic Product Code (EPC) sent flag. In this optional aspect, the method further includes receiving a broadcast Trigger frame from the AMP compliant WiFi device that announces a random access slot for a monostatic backscattering use case and, in response to successfully contending for the random access slot, transmitting a responsive frame including a CRC-based identifier of the AMP tag and setting the EPC flag to 0. In yet another optional aspect, the method further includes transmitting, by the AMP tag, an EPC code of the AMP tag and setting the EPC sent flag to 1. With another optional aspect, the method further includes receiving a unicast Trigger frame addressed to the AMP tag, determining that the EPC sent flag is set to 1 and, in response, transmitting a response to the unicast Trigger frame.

With another illustrative, non-limiting embodiment, an ambient power (AMP) compliant WiFi device includes a one or more wireless transceivers and one or more processing modules operably coupled to the one or more wireless transceivers. The one or more processing modules are arranged to communicate, from an upper layer of a MAC layer (“upper layer”) of the WiFi device to the MAC layer of the WiFi device, a request primitive to solicit a response from an upper layer of an AMP tag, wherein the request primitive of the WiFi device utilizes a different set of parameters than a request primitive of the AMP tag. The one or more processing modules are further arranged to configure, by the MAC layer of the WiFi device, one or more frames to solicit the response from the AMP tag. The one or more processing modules are further arranged to transmit, via the one or more wireless transceivers, the one or more frames for reception by the AMP tag.

This embodiment includes optional aspects. With one optional aspect, the request primitive of the WiFi device includes a parameter identifying a requested tag type. In another optional aspect, the request primitive of the WiFi device further includes a response delay parameter and a response length parameter.

### BRIEF DESCRIPTION OF THE DRAWINGS

FIG. 1 illustrates an example of an ambient power (AMP) communication system in accordance with embodiments of the present disclosure;

FIG. 2 illustrates an example of an AMP frame exchange protocol in which an 802.11 PPDU includes a single 802.11bp frame change in two 802.11bp PPDUs in accordance with embodiments of the present disclosure;

FIG. 3 illustrates an example of an AMP frame exchange protocol in which an 802.11 PPDU may include multiple 802.11bp frame changes in multiple 802.11bp PPDUs in accordance with embodiments of the present disclosure;

FIG. 4 illustrates an example of AMP primitives, MAC frame exchanges and operation of an EPC sent flag in accordance with an embodiment of the present disclosure;

FIG. 5 illustrates another example of AMP primitives, MAC frame exchanges and operation of an EPC sent flag in accordance with an embodiment of the present disclosure;

FIG. 6 illustrates an example of AMP primitives and MAC frame exchanges for AMP tag authentication in accordance with an embodiment of the present disclosure;

FIG. 7 illustrates an example of AMP primitives and MAC frame exchanges for an AMP tag read operation in accordance with an embodiment of the present disclosure; and

FIG. 8 is a flow chart illustrating an example method for communicating information between an AMP compliant first device and an AMP compliant second device in accordance with one or more embodiments of the present disclosure; and

FIG. 9 is a flow chart illustrating an example method for communicating with an AMP compliant WiFi device by an AMP tag in accordance with one or more embodiments of the present disclosure.

### DETAILED DESCRIPTION

The various implementations described in the following description relate generally to new frame exchange protocols, primitives and methodologies associated with Ambient Power (AMP) communications with an AMP tag device. More particularly, innovative protocols and primitives are described to support ambient backscatter communications, coexistence mechanisms, wireless power transfer/RF energy harvesting, and other features associated with the IEEE 802.11bp amendment to the IEEE 802.11 standard. Briefly, the 802.11bp amendment is intended to extend IEEE 802.11 MAC and PHY layers to support AMP stations (AMP STAs) that harvest energy for operation.

As used herein, the term “non-legacy” may refer to physical layer protocol data unit (PPDU) formats and communication protocols conforming with the IEEE 802.11bn amendment to the IEEE 802.11 standard (also referred to as Ultra High Reliability or “UHR” or “Wi-Fi 8”) as well as future generations/amendments. In contrast, the term “legacy” may be used herein to refer to PPDU formats and communication protocols conforming to the IEEE 802.11be (also referred to as Extremely High Throughput or “EHT” or “Wi-Fi 7”) or IEEE 802.11ax (also referred to as High Efficiency or “HE” or “Wi-Fi 6/6E”) amendments to the IEEE 802.11 standard, or earlier generations of the IEEE 802.11 standard.

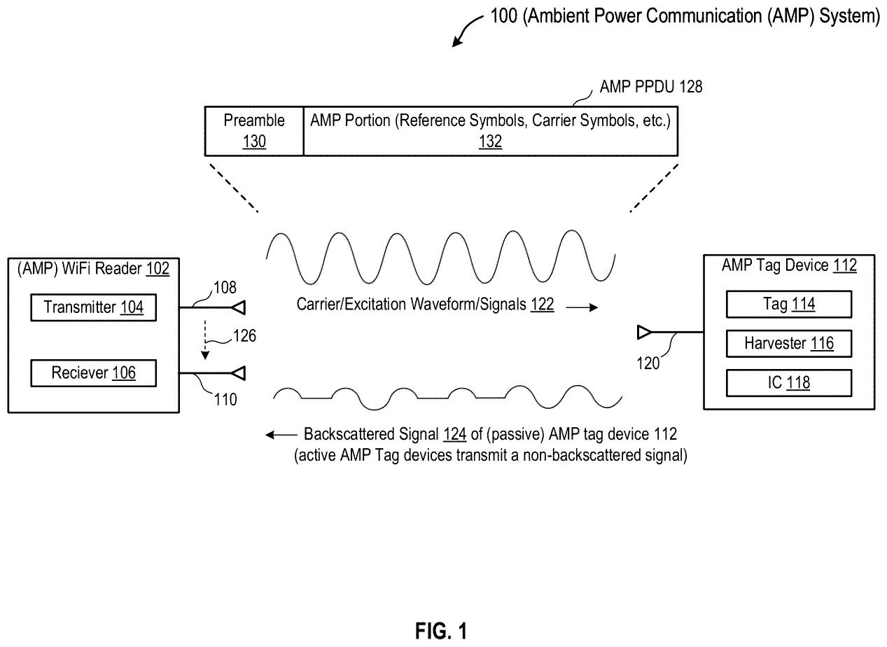

FIG. 1 illustrates an example of an ambient power (AMP) communication system 100 in accordance with embodiments of the present disclosure. The illustrated AMP communication system 100 includes an AMP tag device 112 and a WiFi reader 102 and that is AMP compliant and may operate to read (and in some cases write) data from/to the AMP tag device 112. The AMP tag device 112 and WiFi reader 102 may be implemented by one or more of analog circuitry, mixed-signal circuitry, memory circuitry, logic circuitry, and processing circuitry that executes code stored in a memory(ies) to perform disclosed functions on one or more integrated circuits.

The AMP tag device 112 may be a device compatible with the 802.11bp amendment to the IEEE 802.11 standard. In one or more embodiments, the AMP tag device 112 can be a battery-less backscattering tag device operable in one or more frequency sub-bands such as sub- 1 GHz and 2.4 GHz (or general sub-7 GHz) frequency bands and having one or more antennas 120 for transmitting or receiving in the operating frequency band(s). The AMP tag device 112 is typically a low-cost device and has an energy efficient design by using a low cost voltage controlled oscillator (VCO) with no crystal and phase lock loop (PLL). The AMP tag device 112 may also have an integrated circuit (IC) 118 to facilitate transmitting or receiving signals in the one or more frequency bands based on timing of the VCO. A received signal may indicate a request from the WiFi reader 102 to read or write data in a memory of the AMP tag device 112 (also referred to herein as tag 114) and a transmitted signal may indicate data stored in the tag 114 or a response to a write operation. A received signal may indicate a request from the WiFi reader 102 to authenticate the AMP tag device 112. The AMP tag device 112 may further include a harvester 116 which extracts power from a (energizing/excitation) waveform 122 transmitted by the AMP compliant WiFi reader 102 and incident on the antenna 120 in order to operate the integrated circuit (IC) 118 to receive and transmit signals.

An AMP tag device 112 may include an AMP IoT device, which can function as sensors, monitors, actuators, etc. for various applications that may require low cost and maintenance-free/battery-less devices and/or small form factor devices. Such applications may include, for example, smart manufacturing, environmental sensing and monitoring (e.g., in data centers), asset management, smart home sensing and monitoring, smart agriculture applications, indoor positioning, smart power grid applications, food supply chain monitoring, etc. Such devices should also be backward compatible with existing WiFi signals and communications (e.g., 20 MHz channel bandwidths, symbol-based waveforms, and higher carrier frequencies (2.4 GHz, 5 GHz, 6 GHZ, etc.).

In one or more embodiments, the waveform 122 may be a carrier waveform or energizing (carrier) waveform on which the data transmitted by the WiFi reader 102 is modulated, and on which the AMP tag device 112 backscatters data by modulation to define the signals transmitted by the AMP tag device 112. To transmit and receive the signals, the WiFi reader 102 of this example includes a transmitter 104, receiver 106 and one or more antenna such as antenna 108 and antenna 110. The WiFi reader 102 may take the form of a smart phone, smart home hub, public transportation hotspot, dedicated reader device, etc., and be compatible with one or more legacy and/or non-legacy amendments to the IEEE 802.11 standard.

The WiFi reader 102 of this example operates to transmit and receive WiFi signals in addition to signals transmitted for the operation of the AMP tag device 112. To achieve co-existence with other legacy WiFi devices (e.g., devices which do not support AMP communication), the WiFi reader 102 is arranged to transmit the waveform 122 to the AMP tag device 112 in the form of an AMP physical layer protocol data unit (PPDU) 128 including a preamble 130 having symbols that define a legacy WiFi preamble, e.g., a 802.11b preamble or legacy orthogonal frequency division multiplexed (OFDM) preamble (e.g., 802.11g/n/ac/ax/be), and a payload/AMP portion 132 of the PPDU. By including the legacy preamble, the AMP PPDU 128 is configured to allow other WiFi readers or legacy WiFi devices (not shown and not AMP compliant) to be able to decode the legacy preamble of the AMP PPDU 128 and backoff from transmitting for the duration of the AMP PPDU 128 (as indicated by the preamble) so as not to interfere with AMP communication between the WiFi reader 102 and the AMP tag device 112.

In one or more embodiments, the WiFi reader 102 may read data from the tag 116, write data to the tag 116, or authenticate the tag 116 by transmitting the AMP PPDU 128. The AMP PPDU 128 transmitted as the waveform 122 is incident on the antenna 120 of the AMP tag device 112. For passive AMP tag devices 112 that rely on backscattered communications, the harvester 116 of the AMP tag device 112 may harvest power from the waveform 122 defining the AMP PPDU 128 to power the IC 118 to receive and decode symbols in an AMP portion 132 of the PPDU which is in the payload of the AMP PPDU 128. Based on the symbols that are decoded in the AMP PPDU 128, the IC 118 may cause the AMP tag device 112 perform a read operation, write operation or authenticate operation and transmit a response. The AMP tag device 112 may transmit the response by a backscattering process which involves modulating a portion of the waveform 122 incident on the antenna 120 to generate a backscatter signal 124. The impedance of the antenna 120 may be modulated based on bits of the response to modulate an amount of incident RF energy and scatter the amount of incident energy on the antenna 120 to transmit bits of the response from the AMP tag device 112 to the WiFi reader 102 as backscattering. The response may be data stored in the tag 116 (e.g., an identifier associated with the tag, sensor measurement data, etc.) or a protocol compliant response control message. The WiFi reader 102 will then receive this backscatter signal 124. In some embodiments, the WiFi reader 102 may further send an acknowledgement to indicate the receipt of the uplink communication (e.g., a write operation).

The modulation clock accuracy of AMP tag device 112 may be very limited, e.g., 100,000 parts per million (ppm) variation due to a low cost design. The ppm may be measure of a variation of modulation accuracy such as a 1 Hz change in frequency for every 1 MHz of frequency. Further, complexity associated with the reading of data may need to be put onto the WiFi reader 102 which needs to resolve a large sampling frequency offset (SFO) of the VCO of the AMP tag device 112.

In one or more embodiments, the WiFi reader 102 may need to send a well-designed waveform 122 to define the AMP PPDU 128. The waveform 122 may be the carrier waveform with a repeated base waveform. This way, signal leakage 126 from transmit antenna 108 to receive antenna 110 due to antenna coupling can be removed and the backscattered signal received by the WiFi reader 102 is able to be decoded with better signal-to-interference-and-noise ratio (SINR). The antenna coupling may be leakage of a signal transmitted by the transmitter 104 and received at the receiver 106. The waveform 122 may have defined design criteria such as a low peak to average power ratio (PAPR) to enable higher transmit power and better receive signal-to-noise ratio, a low power fluctuation for a duration of every symbol for which On-Off keying (OOK) modulation is applied for backscattering, and small spectral leakage due to the OOK. In an example, for 250 kbps OOK with Manchester encoding, a symbol duration is 2 us, while for 1 Mbps OOK with Manchester encoding, a symbol duration is 0.5 us. The OOK with Manchester encoding is a method of transmitting data where the waveform 122 is either on or off to represent a ‘1’ or ‘0’ bit, and the Manchester encoding ensures a transition occurs at the start of each bit period, aiding clock recovery and data integrity.

Signal leakage 126 may have a relatively high power and the same timing as the waveform 122, and the backscatter signal 124 received at the receiver 106 of the WiFi reader 102 may be masked by the signal leakage 126 which typically has a higher power. The WiFi reader 102 needs to remove this signal leakage 126 from a received signal at the receiver 106 to recover the backscatter signal 124 using a leakage estimation and removal process. Many ways for removing this signal leakage 126 are possible.

In one or more embodiments, a leakage in an Nth symbol of the AMP PPDU 128 that is received where N is an integer may be removed by subtracting a waveform of the N−1th symbol that is already received from a waveform of the Nth symbol. The differencing may reduce the signal leakage 126 but could result in destroying the Nth symbol modulation. In one or more embodiments, the WiFi reader 102 may transmit reference symbols in the AMP PPDU 128 and determine leakage of the reference symbols between the transmitter 104 and the receiver 106. The reference symbols may be predefined symbols that represent a predefined data sequence. Then, the WiFi reader 102 may transmit subsequent carrier symbols which the AMP tag device 112 receives in the AMP PPDU 128. The AMP tag device 112 may receive the AMP PPDU 128 and modulate data on a waveform of the carrier symbols based on backscattering to transmit data back to the WiFi reader 102, and the modulation parameters are determined based on control information in an AMP portion of the PPDU such as AMP data transmitted to the AMP tag device 112 which may also include a synchronization pattern and the reference symbols in some implementations. The reference symbols may have a same format and content as the carrier symbols except for some phase or polarity differences, and the AMP tag device 112 does not backscatter any data within the duration of the reference symbols to allow for accurate signal leakage 126 determination. In some embodiments, the AMP tag device 112 may backscatter data bits to the WiFi reader 102 a predetermined time after sending the carrier symbols to allow for the WiFi reader 102 to estimate the signal leakage 126 based on the carrier symbols received during the non-backscattering time by the receiver 106. The WiFi reader 102 may receive the combined signal leakage 126 and backscattering signal 124 and then subtract the estimated signal leakage 126 based on reference symbols from the received signal to remove the signal leakage 126 and recover the backscatter signal 124 without the signal leakage 126.

In one or more embodiments, the WiFi reader 102 may send reference symbols periodically in the AMP PPDU 128 and instruct the AMP tag device 112 to skip performing a backscattering every N reference symbols for the WiFi reader 102 to determine the signal leakage 126. The estimation process may include estimating the reference symbols which are received based on the transmitted reference symbols to estimate the signal leakage 126. The WiFi reader 102 may then subtract, at the receiver 106, the estimated signal leakage 126 based on the reference symbols from a received signal to recover the backscatter signal 124 and remove the signal leakage 126. The periodic sending of the reference symbols or determining the signal leakage 126 allows for improving the signal leakage 126 estimation and recovery of the backscattered signal with higher signal-to-noise ratio.

The portion of the waveform 122 that defines the reference symbols associated with leakage estimation and the carrier symbols that are backscattered may not be simple repeated symbols that cause a spectrum spike and violate transmit requirements. The portion of the waveform 122 may also be a known waveform that is received at the receiver 106 for signal leakage 126 estimation. The phase or polarity on the portion of the waveform 122 for signal leakage 126 estimation may need to be removed to perform the carrier symbol leakage estimation. In one or more embodiments, the portion of the waveform 122 may be an existing WiFi single-carrier waveform, e.g., as defined by IEEE 802.11b. The receiver 106 may need to remove any modulation (e.g., differential binary phase shift keying (DBPSK)) of 802.11b from the reference symbol portion of the waveform 122, estimate the leakage signal of the reference symbols, and regenerate carrier symbols with modulation recovered for signal leakage 126 removal. As a result, a waveform of the regenerated carrier symbols is subtracted from a received signal at the receiver 106 to recover the backscattered signal 124 resulting from backscattering a waveform of carrier symbols in the AMP PPDU 128 for signal leakage 126 removal.

While the foregoing description relates generally to backscattered communications, various methodologies described herein are likewise applicable to non-backscattered communications, such as those involving active or battery-powered tag devices that do not require (or only periodically require) an energizing waveform.

As used herein, a Medium Access Control Service Access Point (MAC SAP) refers to the interface between a MAC sublayer and higher sublayers (e.g., Logic Link Control (LLC)), and primarily functions to convey MAC Service Data Units (MSDUs) (actual user data packets) to and from the upper layers. For example, a MAC SAP handles requests to send a packet and indications that a packet has been received. As may be used herein, a MAC Layer Management Entity (MLME) refers to the management component of a MAC layer that is responsible for all internal management and control functions (e.g., association, authentication, scanning, timing, wireless power transfer, power management, etc.) that are not actual data transmission handled by a MAC data path.

In an example, an AMP tag may include AMP Control Logic (the tag's SME-equivalent) as the upper layer to the tag's (reduced) MAC layer. In this example, the AMP control logic operates as a lightweight controller (as compared to a full 802.11 Station Management Entity (SME)) that interprets AMP commands from a reader device, issues transmit, access and query responses, configures minimal MAC parameters, manages the tag's ID or payload, controls sleep/wake cycles, etc.

The term “primitive” as used herein refers to a formal/standardized message used for communication between a MAC layer and the layer above it (e.g., Logic Link Control (LLC)). A primitive may be a command or notification that triggers or reports a service at a (MAC or MLME) SAP. For example, a primitive may express a request for a service (e.g., “send this data” or “start wireless power transfer”), a confirmation that the service completed, an indication that something happened (e.g., data arrived), or a response to an indication. In general, a request primitive (of a reader or tag) flows from a higher/upper layer to a MAC/MLME, while an indication primitive flows from a MAC/MLME to a higher/upper layer and relates to an event that was not requested by the higher layer.

For a backscatter tag application, given that the AMP reader (AP) and the AMP tag (STA) have different capabilities (e.g., all tag transmissions are solicited by the reader), the AMP reader's MAC SAP primitive and AMP tag's primitive are different. Likewise, for an active tag application, given that the AMP reader (AP) and the AMP tag (STA) have different capabilities (e.g., all tag transmissions are solicited by the reader), the AMP reader's MAC SAP primitive and AMP tag's primitive are different. Novel primitives for an AMP MAC SAP are described more fully below.

In a first example, a request primitive for an AMP reader's MAC SAP includes the following parameters: Tag type (backscatter tag or non-backscatter tag), RA (recipient address/ID, which may be a unicast or broadcast ID), Data (information being exchanged from reader to tag), responding delay (the time, starting at the end of the soliciting PPDU, required by the tag to prepare a responding frame), responding frame length, Tx data rate (not required if link adaptation is performed in the MAC layer), and Rx data rate (not required if the link adaptation is performed in the MAC layer). In some embodiments, the responding delay may be predefined for different operations in the MAC layer such that the AMP reader and AMP tag can determine the responding delay based on the type of command.

In a second example, a request primitive for an AMP reader's MAC SAP includes the following parameters: Tag type (backscatter tag or non-backscatter tag), RA (recipient address/ID, which may be a unicast or broadcast ID), Data (information being exchanged from reader to tag), responding delay (the time, starting at the end of the soliciting PPDU, required by the tag to prepare a responding frame), responding frame length, Random Slot number (required when a broadcast ID is utilized), Threshold for random access, Tx data rate (not required if link adaptation is performed in the MAC layer), and Rx data rate (not required if the link adaptation is performed in the MAC layer).

In a third example, an indication primitive for an AMP reader's MAC SAP includes the following parameters: Tag type (backscatter tag or non-backscatter tag), TA (transmitter address/ID (unicast ID)), Data (information being exchanged from tag to reader), and Status (success or failure; if failure, the other parameters in the primitive are not valid).

In a fourth example, a request primitive for an AMP tag's MAC SAP includes the following parameters: Tag type (backscatter tag or non-backscatter tag), TA (transmitter address/ID (unicast ID)), Data (information being exchanged from tag to reader), responding frame length (may not be needed if the Data parameter can provide this information), and Tx data rate.

In a fifth example, an indication primitive for an AMP tag's MAC SAP includes the following parameters: Tag type (backscatter tag or non-backscatter tag), RA (recipient address/ID (unicast ID)), Transaction ending indication, and Data (information being exchanged from tag to reader).

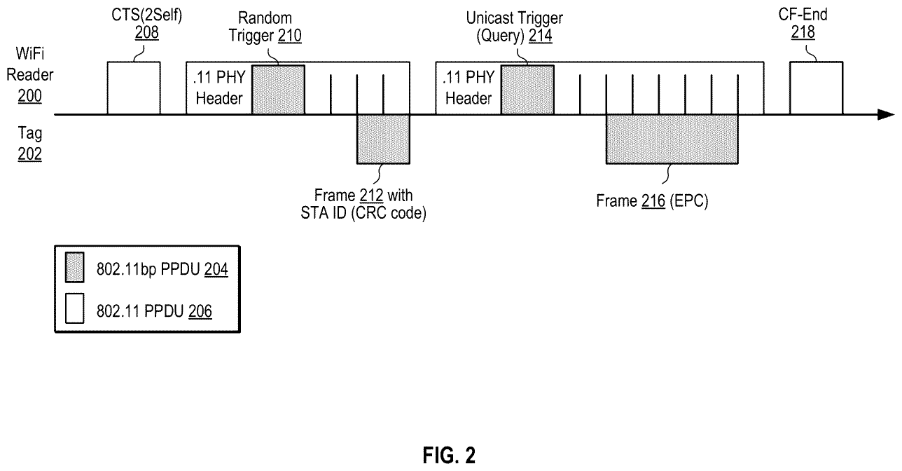

FIG. 2 illustrates an example of an AMP frame exchange protocol in which an 802.11 PPDU includes a single 802.11bp frame change in two 802.11bp PPDUs in accordance with embodiments of the present disclosure. The illustrated frame exchange protocol is performed between a WiFi reader 200 (or “AMP AP”) and an AMP tag 202 (or “AMP non-AP STA”), such as the WiFi reader 102 and AMP tag device 112 described with reference to FIG. 1. As used herein, a “frame exchange” or “frame change” refers to an internal MAC state machine event that signals the transition from processing one frame to another, and is used to coordinate transmit/receive logic, backoff, NAV, and timing. For example, a frame exchange occurs when there is a transition in a MAC's transmit/receive processing state caused by the arrival, completion, or replacement of a frame in the MAC's internal pipeline.

In the illustrated example, the frame exchange protocol begins when the WiFi reader 200 transmits a medium reservation CTS or CTS-to-Self (CTS2Self) frame 208. The CTS2Self frame 208 functions to protect the subsequent frame exchange sequence and includes a duration field carrying a value indicating a wireless medium reservation duration for the WiFi reader 200. The value of the duration field can be dynamic depending on an unknown number of recipient tags in the field and the error recovery mechanism that is utilized (e.g., for resolving collisions in a multi-tag environment), and the medium reservation duration can be conservatively set based on an expected number of tags to be read.

The WiFi reader 200 of this example further transmits a first 802.11 PPDU 206 for receipt by a (AMP) tag 202 and, in some embodiments, additional tags within operating range of the WiFi reader 200. In this example, the first 802.11 PPDU 206 includes an 802.11-based preamble/header configured to provide coexistence with legacy WiFi devices and may include, for example, either an 802.11b preamble or an OFDM preamble defined by 802.11g/n/ac/ax/be. The 802.11-based preamble/header may indicate a duration for the entire PPDU 206.

In an example, in addition to sending control information/commands to the tag 202, the first 802.11 PPDU 206 may serve as the energizing carrier waveform for use by tag 202 in generating a frame 212 through data backscattering. In another example, the first 802.11 PPDU 206 includes an AMP DL waveform/AMP portion(s) that includes both a data segment and a backscattering segment. In the illustrated example, the data segment includes an 802.11bp/AMP preamble (not separately illustrated) and a broadcast or random Trigger frame 210 in an 802.11bp PPDU 204. The AMP preamble may include an AMP DL synchronization (SYNC) sequence (e.g., an OOK modulated sequence) that allows tag 202 to detect the AMP preamble and synchronize and calibrate reception of the Trigger frame 210. In the illustrated example, the random Trigger frame 210 solicits a response frame 212 (in a 802.11bp PPDU 204) from neighboring tags where tag 202 wins the random access to transmit a response frame that includes a tag identifier value (e.g., a 16-bit CRC code of the Electronic Product Code (EPC) that uniquely identifies the tag) of the tag 202. In some embodiments, the 16-bit CRC code of the EPC is the identifier of tag 202 in the MAC header of the following frame exchange.

In the example of FIG. 2, the first 802.11 PPDU 206 transmitted by WiFi reader 200 includes a single 802.11bp frame exchange in two 802.11bp PPDUs 204 and is followed by a second 802.11 PPDU 206 (e.g., by a spacing that is equal to or less than a short interframe space (SIFS)). The second 802.11 PPDU 206 transmitted by the WiFi reader 200 includes a unicast Trigger frame 214 having a MAC header that includes the STA ID of tag 202, and also carries a Query command (e.g., an EPC data request) addressed to tag 202. In the illustrated example, tag 202 decodes the unicast Trigger frame 214, communicates an indication primitive to its upper layer, and communicates (from the upper layer to the MAC layer) a request primitive solicited by the indication primitive. Based on the request primitive, the tag 202 of this example generates and transmits a frame 216 including a responsive EPC value in a (backscattered) 80211.bp PPDU 204. Following completion of the read sequence, the WiFi reader 200 may transmit a CF-End frame 218 to release a remaining portion of the wireless medium reservation duration. In the frame exchange sequence of this example, an 802.11 PPDU includes two 802.11bp frame exchanges in the frame exchange sequence by using two 802.11bp PPDUs. In addition, the request and indication primitives of the MAC SAP interface of WiFi reader 200 and the upper layer interface of tag 202 can include differing parameters as described above.

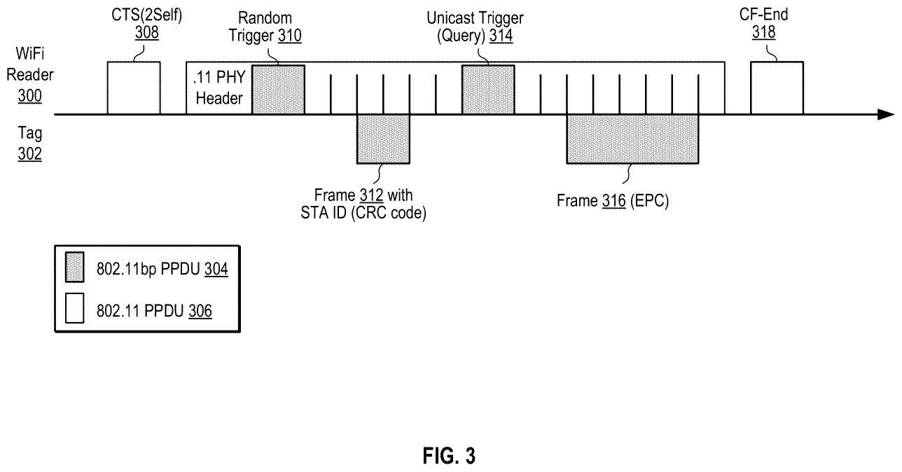

FIG. 3 illustrates an example of an AMP frame exchange protocol in which an 802.11 PPDU may include multiple 802.11bp frame exchanges in multiple 802.11bp PPDUs in accordance with embodiments of the present disclosure. The illustrated frame exchange protocol is performed between a WiFi reader 300 and an AMP tag 302, such as the WiFi reader 102 and AMP tag device 112 described with reference to FIG. 1.

In the illustrated example, following a CTS2Self frame 308 for TXOP protection, a frame exchange sequence including random Trigger frame 310, response frame 312, unicast Trigger frame 314, and frame 316 for RFID information exchange functions as described with reference to the similarly labeled frame exchange sequence including random Trigger frame 210, response frame 212, unicast Trigger frame 214, and frame 216 of FIG. 2. Similar to the example of FIG. 2, the frame exchange sequence for RFID information exchange is followed by CF-End frame 318. In the example frame exchange protocol of FIG. 3, however, each of the 802.11bp PPDUs 304 and associated frame exchanges are included within a single 802.11 PPDU 306.

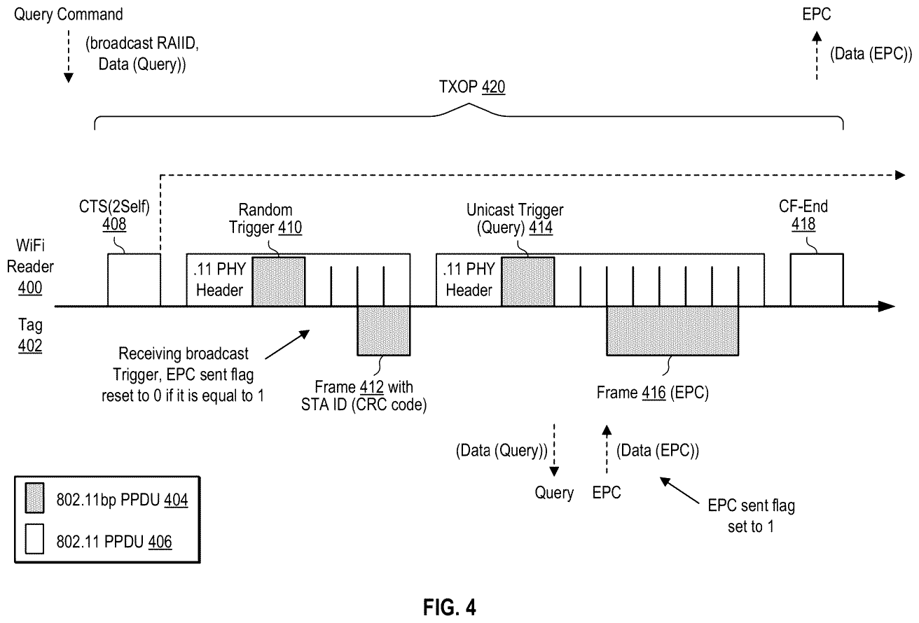

FIG. 4 illustrates an example of AMP primitives, MAC frame exchanges and operation of an EPC sent flag in accordance with an embodiment of the present disclosure. The illustrated frame exchange protocol is performed between a WiFi reader 400 and an AMP tag 402, such as the WiFi reader 102 and AMP tag device 112 described with reference to FIG. 1.

In the illustrated example, following a CTS2Self frame 408 for TXOP protection, a frame exchange sequence including random Trigger frame 410, response frame 412, unicast Trigger frame 414, and frame 416 for RFID information exchange functions as described with reference to the similarly labeled frame exchange sequence of FIG. 2 including CTS2Self frame 208, random Trigger frame 210, response frame 212, unicast Trigger frame 214, and frame 216 for RFID information exchange. In the illustrated example, CTS2Self frame 408 and CF-End frame 418 function as described with reference to CTS2Self frame 208 and CF-End frame 218. In the frame exchange protocol of FIG. 4, each of the 802.11 PPDUs 406 is transmitted during a transmit opportunity (TXOP) 420.

In one embodiment of the illustrated example, an AMP Query command is issued by the up(per) layer of the MAC layer of WiFi reader 400, which sits above its MAC SAP and issues AMP primitives. In another embodiment of the illustrated example, an AMP Query command is issued by an SME (Station Management Entity) of WiFi reader 400, which sits above its MAC SAP and issues AMP primitives. The AMP Query command may include cryptographically protected broadcast Robust Authentication and Integrity Infrastructure Data (RAIID) information, a CRC code request, etc.

In the illustrated example, the tag 402 maintains an EPC sent flag (which may be referred to in the alternative as an “Identified by the AP” flag). In an example, each time a broadcast Trigger frame is received by the tag 402, the tag 402 sets the EPC sent flag to 0 if it is equal to 1. Continuing with this example, each time the tag 402 sends its EPC, the tag's EPC sent flag is set to 1. In another example, a state in which the EPC sent flag is equal to 0 is considered “state A” and a state in which the EPC sent flag is equal to 1 is considered “state B”. In an example, state A and state B are associated with one of the three sessions and the corresponding soliciting frame carries a session ID to identify one of the three sessions. In addition, when the EPC sent flag is set to 1 and the tag 402 receives a unicast Trigger frame addressed to it, the tag 402 will send the corresponding response. In certain circumstances (e.g., when two tags have the CRC-based STA identifier), the tag 402 may receive a unicast Trigger frame addressed to it when the EPC sent flag is set to 0. In an example, the tag 402 does not send a response to the unicast Trigger frame when this situation occurs.

In the example of FIG. 4, tag 402 decodes the unicast Trigger frame 414, communicates a corresponding data query indication primitive to its upper layer, and communicates (from the upper layer to the MAC layer) a request primitive solicited by the indication primitive to initiate transmission of frame 416 (assuming the EPC sent flag is set to 1). The frame 416 of this example includes an EPC value associated with tag 402. In this example, the MAC SAP of the WiFi reader 400 communicates an indication primitive including the EPC value to an up(per) layer of its MAC layer. After the up layer of the MAC layer receives the EPC of tag 402, it determines whether a further information exchange with tag 402 is required. In this example, the up layer of the MAC layer determines that no further information exchange with tag 402 is required.

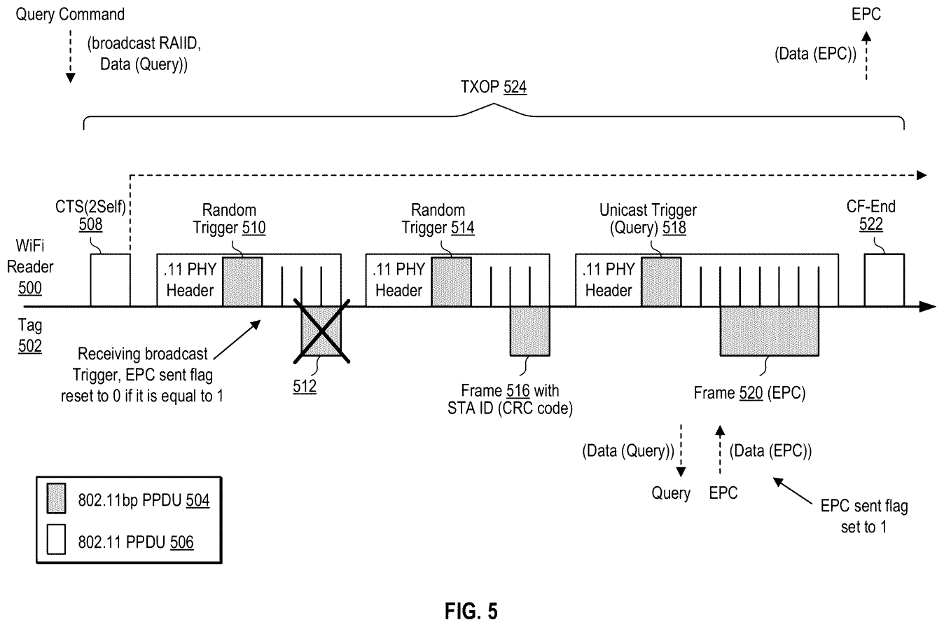

FIG. 5 illustrates another example of AMP primitives, MAC frame exchanges and operation of an EPC sent flag in accordance with an embodiment of the present disclosure. The illustrated frame exchange protocol is performed between a WiFi reader 500 and an AMP tag 502, such as the WiFi reader 102 and AMP tag device 112 described with reference to FIG. 1. In an example, each of the 802.11 PPDUs 506 of FIG. 5 is transmitted during a transmit opportunity (TXOP) 524 of WiFi reader 500.

In the illustrated example, following a CTS2Self frame 508 for TXOP protection, a frame exchange sequence including random Trigger frame 514, response frame 516, unicast Trigger frame 518, and frame 520 functions as described with reference to the similarly labeled frame exchange sequence of FIG. 2 including random Trigger frame 210, response frame 212, unicast Trigger frame 214, and frame 216. In the illustrated example, CTS2Self frame 508 and CF-End frame 522 function as described with reference to CTS2Self frame 208 and CF-End frame 218. In the frame exchange protocol of FIG. 5, however, a first random Trigger frame 510 is transmitted by WiFi reader 500 in a first 802.11 PPDU 506, but a response frame 512 is not received from any tag, e.g., due to collision or because no tag receives the broadcast Trigger frame 510. In an example, the WiFi reader 500 transmits an additional random Trigger frame 514 to solicit tag responses where tag 502 wins the random access and transmits a responding frame with the STA ID (e.g., CRC code) of tag 502. In this example, the WiFi reader 500 further performs the frame exchange sequence to acquire the EPC of tag 502 in order for the up layer of the MAC layer to decide whether further information exchange with the tag 502 is required.

In the illustrated example (and as described with reference to FIG. 4), the tag 502 maintains an EPC sent flag. In operation, each time a broadcast Trigger frame is received by the tag 502, the tag 502 sets the EPC sent flag to 0 if it is equal to 1. Continuing with this example, each time the tag 502 sends its EPC, the tag's EPC sent flag is set to 1. By maintaining the EPC sent flag, the tag 502 may avoid unnecessarily transmitting its EPC value, thereby helping to reduce channel congestion.

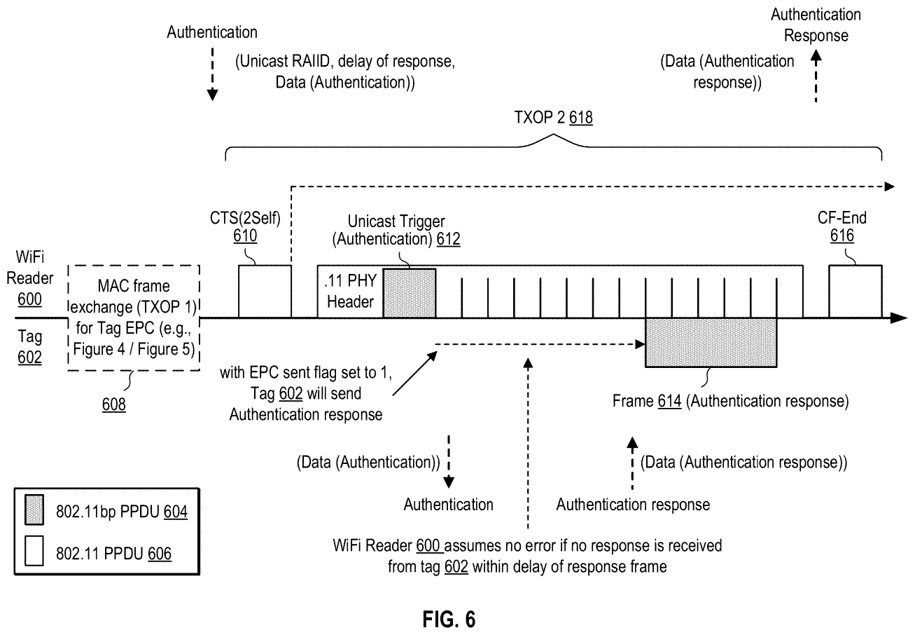

FIG. 6 illustrates an example of AMP primitives and MAC frame exchanges for AMP tag authentication in accordance with an embodiment of the present disclosure. The illustrated frame exchange protocol is performed between a WiFi reader 600 and an AMP tag 602, such as the WiFi reader 102 and AMP tag device 112 described with reference to FIG. 1. In this example, an initial MAC frame exchange 608 between the WiFi reader 600 and tag 602 is performed, during which the EPC of the tag 602 is read by the WiFi reader 600 in a first TXOP (TXOP 1). Examples of a MAC frame exchange 608 are described with reference to FIG. 4 and FIG. 5. In an example, after the up layer of the MAC layer of WiFi reader 600 receives the EPC of tag 602, the up layer determines that authentication with tag 602 is required. Accordingly, the MAC frame exchanges of this example further include an exchange of 802.11bp PPDUs 604 (in 802.11 PPDUs 606) during a second TXOP (TXOP 2 618) for purposes of performing an AMP tag authentication procedure.

In the illustrated example, an AMP Authentication command is issued by an SME (upper layer) of WiFi reader 600. The AMP Authentication command may include a delay of response value, an authentication data request, the STA ID of the addressed tag, the UL data rate, etc. In this example, the WiFi reader 600 transmits a CTS2Self frame 610 that functions to protect the subsequent frame exchange sequence and includes a duration field carrying a value indicating a wireless medium reservation duration for the WiFi reader 600.

The WiFi reader 600 of this example further transmits a 802.11 PPDU 606 for receipt by a (AMP) tag 602 that includes an 802.11-based preamble/header. In the illustrated example, the 802.11 PPDU also includes a unicast Trigger frame 612 carrying an Authentication command (e.g., a request for authentication information) addressed to tag 602. The unicast Trigger frame 612 is included in an 802.11bp PPDU 604. In the illustrated example, tag 602 decodes the unicast Trigger frame 612, communicates a corresponding authentication indication primitive to its upper layer, and communicates (from the upper layer to the MAC layer) a request primitive solicited by the indication primitive to initiate transmission of frame 614.

In an example, the request primitive of the WiFi reader 600 supports information exchange with tag 602 by carrying a delay of response frame. In the illustrated example, WiFi reader 600 does not assume an error has occurred if a response from tag 602 is not received SIFS after the 802.11bp PPDU carrying the unicast Trigger frame 612. In another example, the MAC layer of the WiFi reader 600 determines whether to utilize a delay time other than SIFS between the soliciting PPDU carrying the soliciting frame (e.g., Trigger frame 612) and the responding PPDU carrying the responding frame (e.g., frame 614) based on the command carried in the soliciting frame. In an example, instead of utilizing a delay of response frame longer than the SIFS between the soliciting PPDU and the responding PPDU, padding is carried in the soliciting frame, e.g., after the FCS value of the frame or between two FCS values of the frame such that the IFS between the soliciting PPDU and the responding PPDU may be SIFS.

Based on the request primitive, the tag 602 of this example generates and transmits a frame 614 including responsive authentication information in a (backscattered) 80211.bp PPDU 604. Transmission of frame 614 by tag 602 may be conditioned on the status of an EPC sent flag maintained by tag 602. In the illustrated example, the EPC sent flag is set to 1 during frame exchange 608 and tag 602 therefore responds to the unicast Trigger frame 612.

In this example, the MAC SAP of the WiFi reader 600 communicates an indication primitive including the authentication response to an upper layer of its MAC layer. Following completion of the authentication sequence, the WiFi reader 600 may transmit a CF-End frame 616 to release a remaining portion of the wireless medium reservation duration.

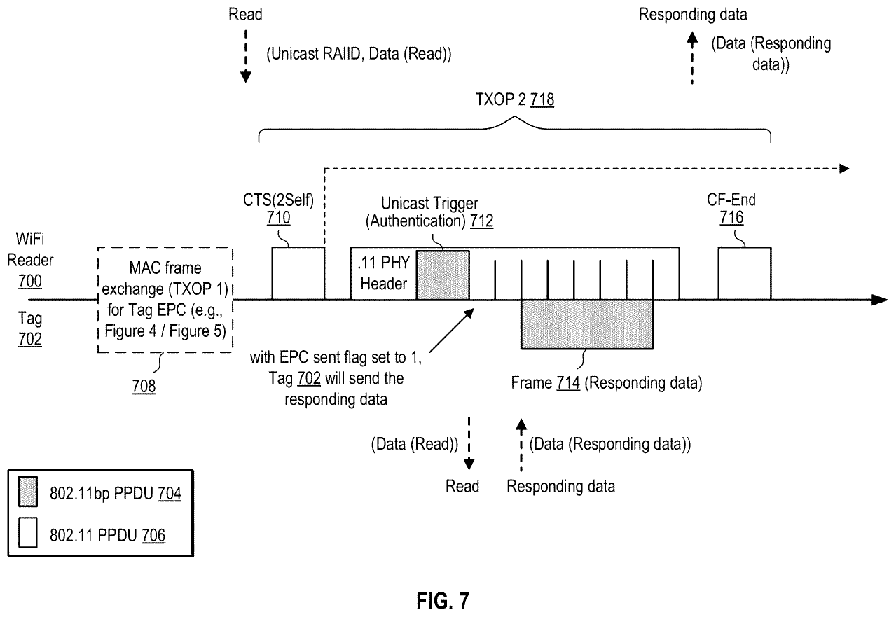

FIG. 7 illustrates an example of AMP primitives and MAC frame exchanges for an AMP tag read operation in accordance with an embodiment of the present disclosure. The illustrated frame exchange protocol is performed between a WiFi reader 700 and an AMP tag 702, such as the WiFi reader 102 and AMP tag device 112 described with reference to FIG. 1. In this example, an initial MAC frame exchange 708 between the WiFi reader 700 and tag 702 is performed, during which the EPC of the tag 702 is read by the WiFi reader 700 in a first TXOP (TXOP 1). Examples of a MAC frame exchange 708 are described with reference to FIG. 4 and FIG. 5. In an example, after the up layer of the MAC layer of WiFi reader 700 receives the EPC of tag 702, the up layer determines that additional information needs to be acquired from tag 702 through a Read command. Accordingly, the MAC frame exchanges of this example further include an exchange of 802.11bp PPDUs 704 (in 802.11 PPDUs 706) during a second TXOP (TXOP 2 718) for purposes of performing an AMP tag read procedure.

In the illustrated example, an AMP Read command is issued by an SME (upper layer) of WiFi reader 700. The AMP Read command includes a read data request, a STA ID of the addressed tag, the UL data rate, etc. In this example, the WiFi reader 700 transmits a CTS2Self frame 710 that functions to protect the subsequent frame exchange sequence and includes a duration field carrying a value indicating a wireless medium reservation duration for the WiFi reader 700.

The WiFi reader 700 of this example further transmits a 802.11 PPDU 706 for receipt by (AMP) tag 702 that includes an 802.11-based preamble/header. In the illustrated example, the 802.11 PPDU also includes a unicast Trigger frame 712 carrying a Read command addressed to tag 702 (e.g., a request for data stored or collected by tag 702). The unicast Trigger frame 712 is included in an 802.11bp PPDU 704. In the illustrated example, tag 702 decodes the unicast Trigger frame 712, communicates a corresponding read indication primitive to its upper layer, and communicates (from the upper layer to the MAC layer) a request primitive solicited by the indication primitive to initiate transmission of frame 714.

Based on the request primitive, the tag 702 of this example generates and transmits a frame 714 including responsive data in a (backscattered) 80211.bp PPDU 704. Transmission of frame 714 by tag 702 may be conditioned on the status of an EPC sent flag maintained by tag 702. In the illustrated example, the EPC sent flag is set to 1 during frame exchange 708 and tag 702 therefore responds to the unicast Trigger frame 712. In other examples, the response frame 714 may include a reject indication if the tag is not able to understand the read command (e.g., due to a version mismatch, an invalid read address, etc.).

In this example, the MAC SAP of the WiFi reader 700 communicates an indication primitive including the responding data to an upper layer of its MAC layer. Following completion of the read sequence, the WiFi reader 700 may transmit a CF-End frame 716 to release a remaining portion of the wireless medium reservation duration. In the illustrated embodiment, the 802.11bp PPDUs 704 may include an AMP PHY header (not separately illustrated).

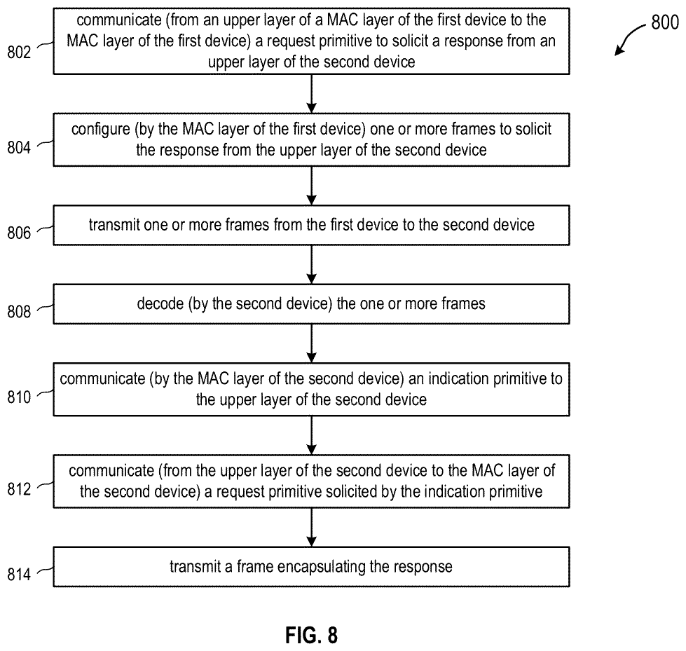

FIG. 8 is a flow chart illustrating an example method 800 for communicating information between an AMP compliant first device and an AMP compliant second device in accordance with one or more embodiments of the present disclosure. In an example, the method 800 can be performed by an AMP compliant WiFi reader (as the first device) and AMP compliant tag device (as the second device), such as the WiFi reader 102 and AMP tag device 112 described with reference to FIG. 1. The method 800 may be utilized, for example, to perform AMP communications involving active or passive AMP tag devices (e.g., in accordance with the 802.11bp amendment to the IEEE 802.11 standard).

The method begins at step 802, where upper layer of a MAC layer (“upper layer”) of the first device (reader) communicates a request primitive to its MAC layer. The request primitive of the illustrated example is intended to solicit a response from an upper layer of the second device (tag). The method continues at step 804, where the first device configures one or more frames in accordance with the request primitive to solicit the desired response from upper layer of the second device. The illustrated method continues at step 806, where the first device transmits the one or more frames to the second device. The method continues at step 808 where the second device decodes the one or more frames transmitted by the first device.

In the illustrated method, the MAC layer of the second device communicates (at step 810) an indication primitive corresponding to the received frame(s) to its upper layer for further processing. The method proceeds to step 812, where the upper layer of the second device communicates a request primitive (as solicited by the indication primitive) to its MAC layer. As described above, the request primitive of the first device can include a different set of parameters than the request primitive of the second device. Various examples of such parameters are described with reference to FIG. 1. The illustrated method continues at step 814, where the second device utilizes the request primitive to prepare and transmit a frame encapsulating the response solicited by the first device.

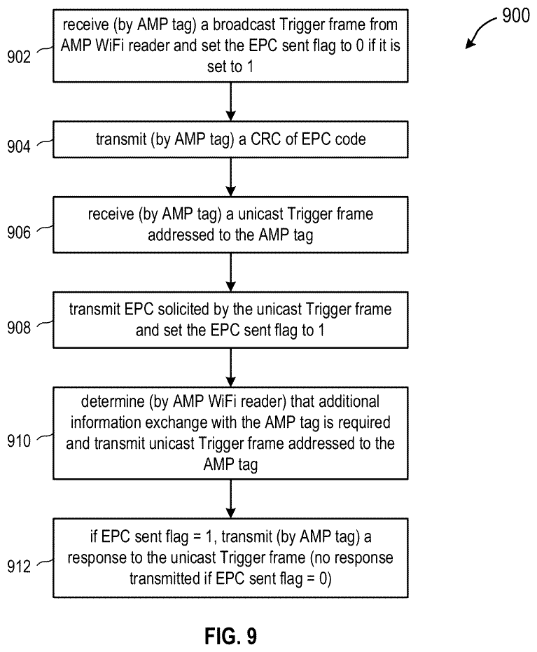

FIG. 9 is a flow chart illustrating an example method 900 for communicating with an AMP compliant WiFi device by an AMP tag in accordance with one or more embodiments of the present disclosure. The method 900 can be performed by an AMP compliant wireless tag, such as the AMP tag device 112 described with reference to FIG. 1, for communicating with a AMP compliant WiFi device such as the WiFi reader 102 of FIG. 1. In the illustrated method, the AMP tag maintains an EPC sent flag that helps track when the AMP tag has identified itself (e.g., via an EPC code) to an AMP reader.

The method begins at step 902, where the AMP tag receives a broadcast Trigger frame from an AMP WiFi reader that announces a single slot for a monostatic backscattering (RFID) use case and one or multiple slots for other use cases. In response to receiving the broadcast Trigger frame, the AMP tag sets its EPC sent flag to 0 (e.g., if it set to 1) at a time the broadcast Trigger frame is received. The illustrated method continues at step 904, where the AMP tag(s) contends for an announced slot through random access, and the AMP tag that obtains use of the slot transmits a CRC of its EPC code for reception by the AMP WiFi reader in response to the broadcast Trigger frame. In this example, the AMP tag subsequently receives (at step 906) a unicast Trigger frame addressed to it for soliciting an EPC of the AMP tag. The method continues at step 908, where the AMP tag transmits its EPC in response to the unicast Trigger frame and sets its EPC sent flag to 1. The illustrated method continues at step 910, where the AMP WiFi reader determines that additional information exchange with the AMP tag is required and, in response, transmits another unicast Trigger frame to the AMP tag. The method continues at step 912, where the AMP tag receives the unicast Trigger frame addressed to it, determines that the EPC sent flag is set to 1, and transmits a response to the unicast Trigger frame. If the EPC sent flag is set to 0, however, the AMP tag refrains from transmitting a response to the unicast Trigger frame.

While the innovative aspects of the present disclosure have been generally described in the context of the 802.11bp amendment to the IEEE 802.11 standard, a person having ordinary skill in the art will readily recognize that teachings and concepts herein may be applied to other wireless networks and standards including, for example, Long Term Evolution (LTE) standards and Bluetooth standards.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may further be used herein, the term(s) “arranged to”, “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with” includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”, “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for communicating information between an ambient power (AMP) compliant first device and an AMP compliant second device, the method comprising:
communicating, from an upper layer of a MAC layer (“upper layer”) of the first device to the MAC layer of the first device, a request primitive to solicit a response from an upper layer of the second device;
configuring, by the MAC layer of the first device, one or more frames to solicit the response from the upper layer of the second device;
transmitting the one or more frames from the first device to the second device;
decoding, by the second device, the one or more frames;
communicating, based on the decoded one or more frames, an indication primitive to the upper layer of the second device; and
communicating, from the upper layer of the second device to the MAC layer of the second device, a request primitive solicited by the indication primitive.

2. The method of claim 1, wherein the request primitive of the first device includes a different set of parameters than the request primitive of the second device.

3. The method of claim 1, wherein the request primitive of the first device includes a parameter identifying a requested tag type.

4. The method of claim 3, wherein the request primitive of the first device further includes a response delay parameter and a response length parameter.

5. The method of claim 1, wherein the request primitive of the first device includes a response delay parameter and a response length parameter.

6. The method of claim 1, wherein the second device is a wireless tag, and wherein the wireless tag maintains an Electronic Product Code (EPC) sent flag.

7. The method of claim 6, further comprising:
receiving, by the wireless tag, a broadcast Trigger frame from the first device that announces a random access slot for a monostatic backscattering use case;
in response to successfully contending for the random access slot, transmitting a responsive frame including a CRC-based identifier of the wireless tag; and
setting the EPC sent flag to 0 if it is set to 1 at a time the broadcast Trigger frame is received.

8. The method of claim 7, further comprising:
transmitting, by the wireless tag, an EPC code of the wireless tag after receiving a unicast soliciting frame that includes the CRC-based identifier in a MAC header of the unicast soliciting frame; and
setting the EPC sent flag to 1.

9. The method of claim 6, further comprising:
receiving, by the wireless tag, a unicast Trigger frame addressed to the wireless tag;
determining that the EPC sent flag is set to 1; and
in response, transmitting a response to the unicast Trigger frame.

10. The method of claim 6, further comprising:
receiving, by the wireless tag, a unicast Trigger frame addressed to the wireless tag;
determining that the EPC sent flag is set to 0; and
in response, determining not to transmit a response to the unicast Trigger frame.

11. The method of claim 1, wherein the one or more frames are compliant with an Institute of Electrical and Electronics Engineers (IEEE) 802.11bp amendment to the IEEE 802.11 standard.

12. A method for communicating with an ambient power (AMP) compliant WiFi device by an AMP tag, the method comprising:
receiving, from the AMP compliant WiFi device, one or more frames, wherein the one or more frames are configured in accordance with a first request primitive from an upper layer of a MAC layer (“upper layer”) of the AMP compliant WiFi device to solicit a response from the AMP tag;
decoding, by the AMP tag, the one or more frames;
communicating, based on the decoded one or more frames, an indication primitive to an upper layer of the AMP tag;
communicating, from the upper layer of the AMP tag to the MAC layer of the AMP tag, a second request primitive solicited by the indication primitive; and
transmitting, by the AMP tag, a frame encapsulating the response.

13. The method of claim 12, wherein the second request primitive includes a different set of parameters than the first request primitive.

14. The method of claim 13, wherein the first request primitive includes a parameter identifying a requested tag type, a response delay parameter and a response length parameter.

15. The method of claim 12, wherein the AMP tag maintains an Electronic Product Code (EPC) sent flag, the method further comprising:
receiving a broadcast Trigger frame from the AMP compliant WiFi device that announces a random access slot for a monostatic backscattering use case;
in response to successfully contending for the random access slot, transmitting a responsive frame including a CRC-based identifier of the AMP tag; and
setting the EPC sent flag to 0.

16. The method of claim 15, further comprising:
transmitting, by the AMP tag, an EPC code of the AMP tag; and
setting the EPC sent flag to 1.

17. The method of claim 16, further comprising:
receiving a unicast Trigger frame addressed to the AMP tag;
determining that the EPC sent flag is set to 1; and
in response, transmitting a response to the unicast Trigger frame.

18. An ambient power (AMP) compliant WiFi device, comprising:
one or more wireless transceivers; and
one or more processors operably coupled to the one or more wireless transceivers, wherein the one or more processors are arranged to:
communicate, from an upper layer of a MAC layer (“upper layer”) of the WiFi device to the MAC layer of the WiFi device, a request primitive to solicit a response from an upper layer of an AMP tag, wherein the request primitive of the WiFi device utilizes a different set of parameters than a request primitive of the AMP tag;
configure, by the MAC layer of the WiFi device, one or more frames to solicit the response from the AMP tag; and
transmit, via the one or more wireless transceivers, the one or more frames for reception by the AMP tag.

19. The AMP compliant WiFi device of claim 18, wherein the request primitive of the WiFi device includes a parameter identifying a requested tag type.

20. The AMP compliant WiFi device of claim 19, wherein the request primitive of the WiFi device further includes a response delay parameter and a response length parameter.
